(19) United States
(12) Patent Application Publication
(10) Pub. No.: US 2011/0010690 A1
(43) Pub. Date: Jan. 13, 2011

(54) System and Method of Automatically Transforming Serial Streaming Programs Into Parallel Streaming Programs

(76) Inventors: Robert S. Howard, Phoenix, AZ (US); Michelle C. Howard, Phoenix, AZ (US)

Correspondence Address: Robert D. Atkins, 605 W. Knox Road, Suite 104, Tempe, AZ, 85284, US

(21) Appl. No.: 12/831,936

(22) Filed: Jul. 7, 2010

Related U.S. Application Data
(60) Provisional application No. 61/223,637, filed on Jul. 7, 2009.

(51) Int. Cl. G06F 9/44

(52) U.S. Cl. 717/120; 717/128

(57) ABSTRACT

A commerce transaction is controlled by transforming serial code segments into parallel code segments. An application is parsed by determining the code segments that must be executed as serial code segments and the code segments that can be executed as parallel code segments. A parallel file is generated for each parallel code segment. The parallel file contains the parallel code segment and the code segments of the application called by the parallel code segment. The application executes through the serial code segments and parallel code segments. When encountering the parallel file, a tag is written to the output stream to reserve a position to write an output value of the parallel file when complete. The parallel file is executed simultaneously with the serial code segment, and the output value of the parallel file is written in the reserved position of the output stream when the parallel file execution completes.

### CLAIM TO DOMESTIC PRIORITY

The present application claims priority to U.S. Application No. 61/223,637, filed Jul. 7, 2009, pursuant to 35 U.S.C. §120.

### FIELD OF THE INVENTION

The present invention relates in general to electronic communication and, more particularly, to a system and method of executing a web scripting language using parallel processing by automatically transforming serial streaming programs into parallel streaming programs.

### BACKGROUND OF THE INVENTION

People use electronic communications in virtually every phase of business and personal activities. The electronic communication is conducted using computer systems and other electronic devices linked together through an open architecture communication network, such as the Internet, and its wired and wireless communication channels and pathways. The Internet provides for communications between parties, information search and retrieval, educational activities, commercial activities, government functions, social networking, and other access to or exchange of information involving the interaction of people, processes, and commerce. For example, electronic communication may involve browsing websites, researching topics of interest, downloading or uploading documents, and sending and receiving emails.

In the electronic communication network, a user operates a computer system which is connected by wired or wireless electronic communication link to the open architecture communication network. A remote server is also connected to the communication network by wired or wireless electronic communication link. The server may contain information of interest to the user. The information on the server is accessible through a website user interface containing one or more webpages maintained by the server. The user opens a local browser on his or her local computer system and enters or accesses the uniform resource locator (URL) address of the server and webpage. The website is routed through the communication network and displayed on the local computer system. The user can navigate the website by transmitting selections and commands through the communication network to search and retrieve the information of interest on the server.

The website is generated from the server using a web scripting language, such as perl, PHP, python, ruby, and javascript. The web scripting language executes a variety of routines or functions, each typically passing one or more parameters to other routines. Each routine executes instructions or statements of code based on the passed parameters and returns possibly one or more parameters back to the calling routine. For example, in response to user input, the local browser transmits a call or request containing one or more parameters, typically in http format, to the server hosting the website. The website server executes a series or sequence of executable statements within one routine or between routines, written in the web scripting language, such as PHP. One PHP routine may call other PHP routines in a hierarchical fashion as necessary to process the parameters sent from the local browser and produce an output stream of ASCII characters.

The ASCII characters are formatted according to a hypertext markup language (HTML), dynamic hypertext markup language (DHTML), extensible markup language (XML), multipurpose internet mail extensions (MIME), or other web based computer readable formats. The ASCII characters are sent back to the local browser in an HTML-formatted source document to display the webpage. The source document controls the display of dynamic content of each webpage on the user's computer system according to standardized rules and structure for encoding text, documents, graphics, and other information. The standardized rules define the appearance and layout of a website through structural semantics for headings, paragraphs, lists, links, quotes, and other items, as well as providing for embedded graphics and scripts.

Conventional streaming programming languages, such as PHP, use a single-threaded, single-process web scripting execution environment that retrieves parameters from a web request, typically from the local browser, and generates a stream of HTML-formatted ASCII characters that is sent back to the browser to be rendered as a webpage on the computer display. The user has the ability to customize the PHP application by uploading PHP files, e.g., plug-ins or extension modules. Currently, the popularity of PHP dominates the web scripting languages, capturing one-third of all web sites, totaling about 80 million. Websites will large followings, like Wikipedia, Yahoo, Facebook, Ning, and Flikr, use PHP. A PHP application, called Wordpress, makes up 20 million sites, or 8.5% of all websites. Conventional PHP applications run a plurality of blocks of code serially where each block can contribute its part of the HTML to the output stream. The order that the code blocks run determine the order that the HTML is generated.

The speed of operation is an important consideration in website design and implementation. The user has come to expect almost instantaneous response, at least as fast as possible, when browsing a website. As the information content associated with the website increases, the response time to load and access the website also increases as more data must be transmitted from the server to the local computer system. If the website takes several seconds to several minutes to load or transmit the information requested by the user, then the user may have a negative impression of the website and choose to go elsewhere for the information. Since most website managers encourage access to their website, website designers strive to maintain fast execution and rapid response times which must be accomplished even with the ever increasing information content.

Web applications are becoming the dominant platform due to the rise of cloud computing, the proliferation of mobile personal devices, such as the iPhone, and the increase of broadband services. Increasing web application functionality has slowed web user loading time, which is detrimental to gaining new users and more ad revenue. New mobile and low bandwidth markets in emerging economies make speed and performance problems even more acute. Emerging cloud and multi-core platforms demand parallel code for best performance, but writing parallel code is very difficult for the average programmer. There is an increasing demand for an automatic software solution that transforms streaming serial applications into ones that can run in parallel to better utilize these new technologies.

One known method of decreasing website access response time involves the use of a web scripting accelerator, which compiles a web script application into a native code. The accelerator increases the performance of web scripts by caching the scripts into a compiled state to reduce or negate the overhead time associated with dynamic compiling. The process of caching the web scripts into a compiled state reduces the server execution load. The accelerator also optimizes scripts to decrease execution time.

However, most web scripting languages are single-threaded or use a single-threaded process, i.e., only one processing core can run the application at a time, even if the host computer has multiple processing cores. In single-threaded instructions, the scripts halt all code execution when any instruction is waiting for another process to complete. Accordingly, while compiling web scripts may speed up the execution of the script instructions, any instruction that blocks or waits for another process query stops all instructions in the application from executing. The application stops until the active routine finishes and returns to the main application execution. In addition, compiled web scripts cannot query databases, socket connections, or web services any faster than non-compiled scripts.

Another known method involves use of a plug-in to cache the output of web script code. The plug-in generates and saves static HTML files for use later. After the HTML files are generated, the server reads the static HTML files, instead of processing the comparatively heavier and more execution time consuming web scripts. However, caching webpages does not speed up the first rendering of a webpage into static HTML pages. If the content changes frequently, caching can degrade the website execution performance.

Another method involves utilization of forked processes or multi-processing in which the web script application is forked into two or more processes that run simultaneously but switch on different blocks of code. One example is the pcntl_fork( ) command. The forked processes are distributed across the multiple cores, typically found in modern servers. Unfortunately, the fork command is not available on many servers; e.g., Windows. Forking distributes processes across the core processors in a single server, but cannot distribute one or more portions of the forked process to remote core processors located on the same network.

Process pooling can also be used to improve website execution performance. Instead of creating a new process for each request, process pooling creates a pool of processes which can be reused. By reducing the overhead of process startup and shutdown, the website requires less time to execute. However, process pooling is typically difficult to implement and distribute requests across many core processors, which does not speed up execution of the web scripting application; a significant portion of website execution performance.

In each case, the ASCII characters are still received and processed serially by the local browser. Each ASCII character must be processed in the order that it is received, and the next ASCII character in the serial stream cannot be handled until the processing of the prior ASCII character is complete. The serial nature of the ASCII characters imposes an inherent bottleneck which the local browser must sequentially process to generate the webpage for the user. The above mentioned techniques to speed up the local browser do not address the underlying shortcoming attributed to serial processing of the ASCII characters to generate the webpage.

### SUMMARY OF THE INVENTION

A need exists to improve webpage execution performance as well as other electronic communication. Accordingly, in one embodiment, the present invention is a method of controlling timing of a commerce transaction by transforming serial code segments into parallel code segments comprising the steps of providing a plurality of code segments in an application which controls timing of a commercial transaction between first and second parties, parsing the application by determining first ones of the code segments that must be executed as serial code segments and second ones of the code segments that can be executed as parallel code segments, and generating a parallel file for each of the parallel code segments. The parallel file contains the parallel code segment and the code segments of the application called by the parallel code segment. The method further includes the steps of transforming the application to associate each parallel file with the parallel code segment, and executing the application through the serial code segments and parallel code segments such that when encountering the serial code segment writing an output value of the serial code segment to an output stream and when encountering the location associated with the parallel file writing a tag to the output stream to reserve a position in the output stream to write an output value of the parallel file when complete, executing the parallel file simultaneously with the serial code segment, and writing the output value of the parallel file in the reserved position of the output stream when the parallel file execution completes. The method controls the timing of the commercial transaction by executing the parallel files simultaneously with the serial code segments.

In another embodiment, the present invention is a method of controlling timing of a commerce transaction by transforming serial code segments into parallel code segments comprising the steps of providing a plurality of code segments in an application which controls timing of a commercial transaction, parsing the application by determining first ones of the code segments that must be executed as serial code segments and second ones of the code segments that can be executed as parallel code segments, and generating a parallel file for each of the parallel code segments. The parallel file contains the parallel code segment and the code segments of the application called by the parallel code segment. The method further includes the steps of transforming the application to associate each parallel file with the parallel code segment, executing the application through the serial code segments and parallel code segments such that when encountering the serial code segment writing an output value of the serial code segment to an output stream and when encountering the location associated with the parallel file reserving a position in the output stream to write an output value of the parallel file when complete, and controlling the timing of the commercial transaction by executing the parallel files simultaneously with the serial code segments.

In another embodiment, the present invention is a method of controlling timing of a commerce transaction by transforming serial code segments into parallel code segments comprising the steps of providing a plurality of code segments in an application which controls timing of a commercial transaction, parsing the application into serial code segments and parallel code segments, executing the application through the serial code segments and parallel code segments such that when encountering the parallel code segment reserving a position in an output stream to write an output value of the parallel code segment when complete, and controlling the timing of the commercial transaction by executing the parallel code segments simultaneously with the serial code segments.

In another embodiment, the present invention is a computer program product comprising computer readable program code embodied in a computer readable medium. The computer readable program code controls timing of a commerce transaction by transforming serial code segments into parallel code segments by providing a plurality of code segments in an application controlling timing of a commercial transaction, parsing the application into serial code segments and parallel code segments, and generating a parallel file for each of the parallel code segment. The parallel file contains the parallel code segment and the code segments of the application called by the parallel code segment. The computer readable program code further transforms the application to associate each parallel file with the parallel code segment, executes the application through the serial code segments and parallel code segments such that when encountering the serial code segment writing an output value of the serial code segment to an output stream and when encountering the location associated with the parallel file reserving a position in the output stream to write an output value of the parallel file when complete, and controls the timing of the commercial transaction by executing the parallel files simultaneously with the serial code segments.

### BRIEF DESCRIPTION OF THE DRAWINGS

FIG. 1 illustrates an electronic communication network for accessing and retrieving information;

FIG. 2 illustrates a website generated by a web scripting language;

FIG. 3 illustrates a general purpose computer for accessing and retrieving information through the electronic communication network;

FIG. 4 illustrates general guidelines for determining functions that can be executed in parallel mode;

FIG. 5 illustrates a PHP web application transformed into serial code segments and parallel code segments;

FIG. 6 illustrates a PHP web application executing in serial mode;

FIG. 7 illustrates a PHP web application executing in parallel mode;

FIGS. 8a-8b illustrate writing with serial code segments and writing with parallel code segments;

FIG. 9 illustrates a state flow diagram of writing with parallel code segments asynchronously;

FIG. 10 illustrates another state flow diagram of writing with parallel code segments asynchronously;

FIG. 11 illustrates a general flow chart of writing with parallel code segments asynchronously;

FIG. 12 illustrates workers connected to the web server within electronic communication network for executing parallel code segments;

FIG. 13 illustrates independent code boundaries processing instructions from two PHP applications;

FIG. 14 illustrates a commercial system controlled by the parallel code;

FIG. 15 illustrates another commercial system controlled by the parallel code; and

FIG. 16 illustrates a process flow of transforming an application into serial code segments and parallel code segments and executing the code segments asynchronously.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

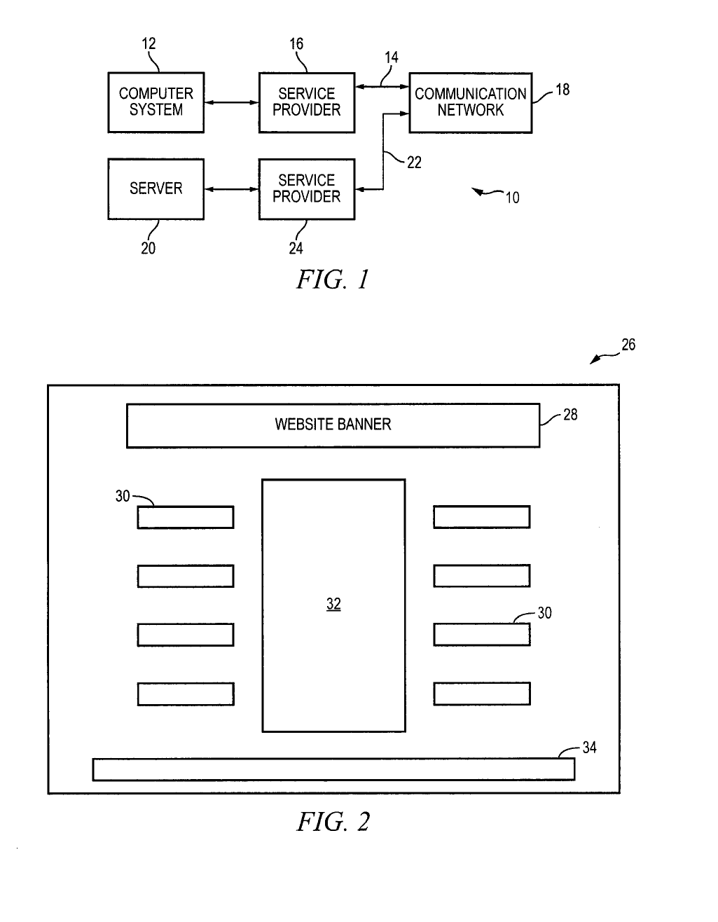

FIG. 1 illustrates an electronic communication network 10. A user operating computer system 12 is connected by wired or wireless electronic communication link 14, through service provider 16, to open architecture communication network 18. A remote server 20 is also connected to open architecture communication network 18 by wired or wireless electronic communication link 22 and service provider 24. Server 20 may contain information of interest to the user. The information on server 20 is accessible through a website user interface 26 containing one or more webpages maintained by the server, as shown in FIG. 2. Website user interface 26 includes website banner 28 containing text and graphics, link blocks 30, graphics block 32, and text block 34. The user opens a local browser on computer system 12 and enters or accesses the URL address of server 20. The website is routed through communication network 18 and displayed on computer system 12. The user can navigate the website by transmitting selections and commands through communication network 18 to search and retrieve the information of interest on server 20. For example, the user can select a link block 30 and be launched to another webpage or be prompted to download a document from server 20. The electronic communication network 10 is an integral part of a business, commercial, professional, educational, government, or social network involving the interaction of people, processes, and commerce.

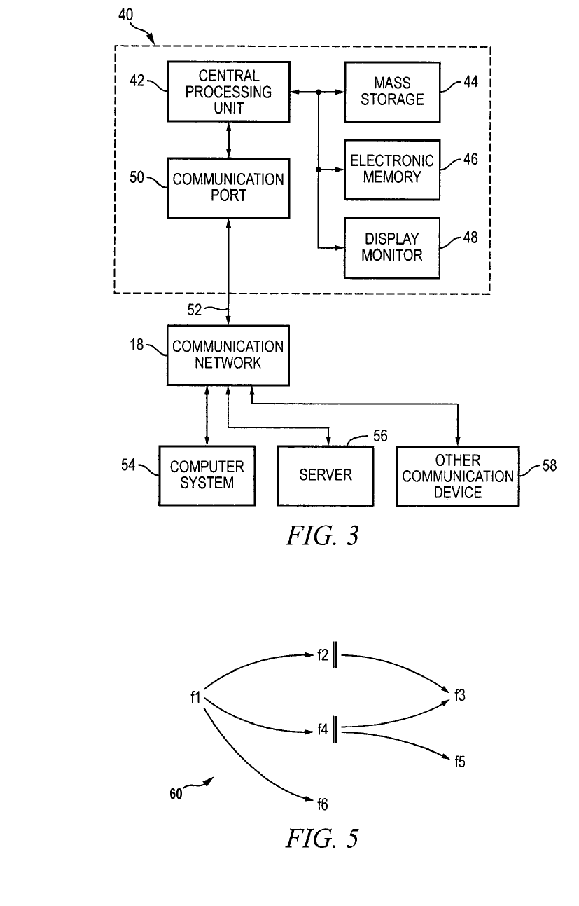

Further detail of the computer systems used in electronic communication network 10 is shown in FIG. 3 as a simplified computer system 40 for executing the software program used in the electronic communication process. Computer system 40 is a general purpose computer including a central processing unit or microprocessor 42, mass storage device or hard disk 44, electronic memory 46, display monitor 48, and communication port 50. Communication port 50 represents a modem, high-speed Ethernet link, wireless, or other electronic connection to transmit and receive input/output (I/O) data over communication link 52 to open architecture communication network 18. Computer system 54 and server 56 can be configured as shown for computer 40. Computer system 54 and server 56 transmit and receive information and data over communication network 18. Other electronic devices 58 can also transmit and receive information and data over communication network 18.

Computer systems 40, 54, and 56 can be physically located in any location with access to a modem or communication link to network 18. For example, computer 40 or 54 can be located in the user's home or business office. Alternatively, computer 40 or 54 can be mobile and follow the user to any convenient location, e.g., remote offices, customer locations, hotel rooms, residences, vehicles, public places, or other locales with electronic access to electronic communication network 18. Server 56 is located in the business office of the company or entity managing website 26.

Each of the computers runs application software and computer programs, which can be used to display user interface screens, execute the functionality, and provide the electronic communication features as described below. The application software includes an Internet browser, word processor, spreadsheet, local email application, and the like. In one embodiment, the screens and functionality come from the local application software, i.e., the electronic communication runs directly on computer system 40. Alternatively, the screens and functions are provided remotely from one or more websites on servers within electronic communication network 10.

The software is originally provided on computer readable media, such as optical disks, external drives, or other mass storage media. Alternatively, the software is downloaded from electronic links, such as the host or vendor website. The software is installed onto the computer system hard drive 44 and/or electronic memory 46, and is accessed and controlled by the computer's operating system. Software updates are also electronically available on mass storage medium or downloadable from the host or vendor website. The software, as provided on the computer readable media or downloaded from electronic links, represents a computer program product containing computer readable program code embodied in a computer readable medium.

Website 26 is generated using a web scripting language, such as perl, PHP, python, ruby, and javascript. The web scripting language executes a variety of routines, each typically passing one or more parameters to other routines. Each routine executes instructions or statements of code based on the passed parameters and returns possibly one or more parameters back to the calling routine. For example, in response to user input, the local browser transmits a call or request containing one or more parameters, typically in http format, to server 20 hosting website 26. The website server 20 executes a series or sequence of executable statements within one routine or between routines, written in the web scripting language, such as PHP. One PHP routine may call another PHP routine in a hierarchical fashion as necessary to process the parameters sent from the local browser and produce an output stream of ASCII characters. The ASCII characters can be formatted according to HTML, DHTML, XML, or other computer readable format. The ASCII characters are sent back to the local browser in an HTML-formatted source document to generate webpage 26. The source document controls the display of dynamic content of the website according to standardized rules and structure for encoding text, documents, graphics, and other information. The standardized rules define the appearance and layout of the website through structural semantics for headings, paragraphs, lists, links, quotes, and other items, as well as providing for embedded graphics and scripts.

The speed of operation is an important consideration in website design and implementation. The user has come to expect almost instantaneous response, at least as fast as possible, when browsing a website. As the information content associated with the website increases, the response time to load and access the website also increases as more data must be transmitted between server 20 and computer system 12.

Web scripting languages, such as perl, PHP, python, and ruby, are commonly used to generate dynamic content in HTML, DHTML, XML, MIME, and other web based computer readable format. For simplicity and consistency, the following discussion primarily references PHP web scripting language, although the application to other languages is understood. PHP coding involves indirect module loading, and evaluations of dynamically generated code. A PHP application is divided into many routines or modules. A main module is called to start the process. In the case of PHP, the main module can be “index.php” as well as any other PHP script file. The main module loads other modules as needed. In PHP, the commands that load other modules are “include”, “include_once”, “require”, and “require_once.” After a module is loaded, it can then load other modules. Modules are typically stored in a plurality of unique files with extension names such as .pl, .php, .py, and .rb. The files are organized into a hierarchy of folders where the root folder contains the main module and defines the application boundary.

PHP is an interpreted language in that the functions and modules are loaded at runtime. PHP typically does not check the types and values of all its variables, classes, and functions before the code is actually executed. PHP displays compiler errors for syntactic problems, such as a missing semicolon, but the compiler permits code to exist that calls functions that do not exist. The interpretative nature of PHP allows functions to be called indirectly through a variable reference. For example, the a.php file is a simple call to a function f that prints out the word “Hello” to the standard output.

<?php
// FILE: a.php
function f( ) { echo “Hello”; }
f( );
?>

The b.php file contains code that calls the function f indirectly. The string variable $x is set to the name of the function f, and the variable is evaluated as a function call.

<?php
// FILE: b.php
function f( ) { echo “Hello”; }
$x = ‘f’;
$x( );
?>

Both a.php and b.php file examples generate the same output. The ability of PHP to call functions indirectly through a string variable creates challenges in determining which parts of the code call which functions. A parser can determine where a function call occurs. If the call is explicit, as shown in the a.php file, then the parser knows which function is called. When the call is implicit, as shown in the b.php file, the parser must know the value of the string variable before it knows which function is being called. In some cases, including the b.php file, the value can be deduced from the previous lines of code. In other cases, the previous code is not so informative. For example, if the code reads the name of the function from an input parameter or a database, or if the value is not the same for every execution of the program, the parser may not be able predict its value.

It is also possible to place functions in one file and call them in another file. For example, the following module1.php file defines the function f and the main1.php file calls the function.

<?php
// FILE: module1.php
echo “Well, ”;
function f( ) { echo “hello”; }
?>
<?php
// FILE: main1.php
include “module1.php”;
f( );
?>

Before the main1.php file can call the function f in the module1.php file, the function f must first be loaded into memory and parsed by PHP.exe, which is the open source program that executes PHP code. The “include” statement in the main1.php file loads the module1.php file from mass storage into the PHP runtime process, and then parses and executes the file. PHP allows the “include” statement to accept a string variable that holds the name of the file to be included. The main1.php file can be written as the main2.php file as follows:

<?php
// FILE: main2.php
$name = “module1.php”;
include $name;
f( );
?>

In this example, the module1.php file is first stored in the string variable $name and then used as a parameter to the “include” statement.

When parallel code is written to make a parallel call to a function, the call must occur outside the function, i.e., at the function call. The function call must know which function is being called before the call is made. The function definitions are executed to parse and load the function into memory, but the actual code in the functions are not executed until the actual function calls are made. However, any code outside the function definitions are executed at the include time. Indirect modules are similar to indirect function calls because when a module is included it is executed. So, including a module necessarily executes all statements outside function definitions, i.e., calling a function to execute the statements inside the function definition. Executing the main2.php file generates the output string “Well, hello.” The string “Well,” is generated when the module is included and the string “hello” is generated when the function f is called.

PHP allows code to be generated dynamically and executed using the “eval” statement, as shown in the following file:

<?php
// FILE: main3.php
$m = “module1.php”;
$code = “include”;
$code = $code . “ ”;
$code = $code . “\”$m\“;”;
$code = $code . chr(102) . “( );”;
echo $code;
eval($code);
?>

The main3.php file outputs the string “include “module1.php”; f( );Well, hello”. The first line sets variable $m to the name of the module to be loaded. The second line sets variable $code to the string “include.” A space is concatenated to the variable $code, and the value of $m is enclosed in quotes, terminated with a semicolon, and concatenated to the variable $code. The 102^{nd} character in the ASCII set (which is the letter “f”) is concatenated to the variable $code followed by a pair of parenthesis and a semicolon. At this point, the variable $code contains a string that represents the code “include “module1.php”; f( )”. The code is stored as a string in a variable named $code. The string is echoed to the output device, and executed with the built-in “eval” function to output the string “Well, hello.”

PHP's dynamic generation of code and runtime evaluation creates challenges for an automated parser to know in advance what is going to be executed. The parser would actually have to run the code to see what value is generated before parsing the actual code stored in the variable. As previously discussed, the code can actually change from run to run if it is based on the value of some input parameters unknown in advance. In summary, any solution to transform PHP code, or any scripting language, must deal with the possibility of indirect function calls, indirect module loading, and evaluations of dynamically generated code.

Two functions f and g can run in parallel if neither shares the same resources, such as memory, files, devices, etc. If the functions f and g do share resources, the functions may still run in parallel, but only under certain conditions. With respect to PHP, the most significant shared resources are files, memory addresses, and database cells.

An important file in PHP is the standard output device (STDOUT) where HTML is written typically via the built-in echo, print, printf, or other write functions. Since PHP is mostly used for building dynamic web applications, writing to the STDOUT is how HTML is sent to the client's browser to be rendered into webpages. Less often, if ever, does a website write to actual disk file. PHP often reads from an XML file, images, or other static configuration files, but seldom ever writes to these files. When PHP does write to a file, the sequential order for appending to a file is significant. Writing an “X” and then writing “Y” yields the output “XY”. Reverse these two operations yields the output “YX”, i.e., reversing the order can change the output.

Most if not all production databases can be treated as a collection of global variables. A column in a row in a table, called a cell, can be written to and read from. Writing to a cell overwrites and destroys the existing value, replacing it with a new value. Just like memory addresses, the order of these create, read, update, and delete operations is significant.

When programming in PHP, as with any other language, the order in which the code executes is significant when the same resource is read from and written to at different places in the code. When code runs serially or sequentially, the order is predictable and understandable. Procedural languages are typically serial, i.e., a sequence of procedures, but some languages have advanced constructs that permit execution of multiple procedures simultaneously, i.e., in parallel. PHP is also procedural language, but lacks these advanced constructs that permit execution of two or more procedures in parallel. For languages that allow these constructs, it is difficult to determine whether two procedures can or cannot run in parallel without breaking logical equivalence. If two procedures can run in any order and still produce the same results, then these two procedures are parallelizable. For example, an application that stores 1 in one variable and 2 in another generates the same results if these two operations are switched or run simultaneously. But when two procedures share common resources, then more analysis is required.

As mentioned previously, if function f writes to a shared resource with function g, then by running functions f and g simultaneously, it becomes unclear which will access the variable first and which will access the variable second. If both read and neither writes, then the order does not matter. In this case, functions f and g can run in parallel. If either function f or function g writes to the variable, then it typically does not matter whether the other function reads or writes to the variable. The outcome is no longer certain and the functions f and g cannot run in parallel.

To illustrate, suppose variable V is initialized to a value of 1. The function f executes independent code and writes a value 2 to variable V. The function g executes independent code and reads the value in variable V. The function g is intended to read the value written by the function f. If the function g reads before the function f writes, because they are running simultaneously, then the function g will read the initial value 1 instead of the value 2 from function f. Since function g depends on the value in variable V written by function f, the functions cannot be parallelized.

Furthermore, executing the code multiple times may not always read the same value from variable V. Race conditions occur when two or more procedures running simultaneously in unpredictable ways access and/or modify the same shared resource. That is, the code does not always run at the same speed. Sometimes the processor gets interrupted with other requests indeterminately. In one execution, the function f may access the shared resource before the function g. In another execution, function g may access the shared resource before the function f. When the functions f and g run sequentially, these interrupts do not matter. Every execution produces the same output, albeit some executions run faster than others. But when the functions f and g run in parallel, then additional precautions must be taken in evaluating the logic of the different possible execution paths.

### Overview of Transformation

A method is presented for transforming serial streaming executable code into parallel executable code that can be run across distributed core processors to improve website execution time. Streaming executable code is a set of instructions that execute one after another in sequential order on one thread, write to a common output buffer, and terminate. For example, a web request to a web application written in PHP is a streaming execution because the request generates HTML, terminates in a time measured in seconds, and runs on a single thread of execution. In general, the transformation speeds up executions of an application by automatically converting a portion of the PHP application to parallel code segments that generate the same output but execute in parallel with respect to the main application. Because the parallel code segment executes simultaneously with the main application, the performance of the website increases.

More specifically, the transformation of the PHP application into a combination of serial code segments and parallel code segments is accomplished by (a) parsing the application into serial code segments and parallel code segments, (b) building character spans of parsed code segments using an expression tree which is formed to allow for easy substitution and transformation, (c) analyzing the results of the parsing and creating a dependency map between the functions and code segments to identify those functions or code segments (parfun) that can run in parallel, (d) propagating reasons to prevent parallelism from functions called to the calling functions, (e) for each parfun, creating a parallel file (parfile) execution package of all code and resources needed for execution, (f) inserting conditional headers into each parfun of the PHP application to skip subsequent code, (g) wrapping two or more function definitions that have the same function name to resolve ambiguity, (h) wrapping calls to parallel functions that return values to declare that they do not use return values in a manner that breaks the original logic of the application, (i) executing the transformed parallel code segments as before but conditionally choosing to write out a unique marker tag and then skipping the function to instead run its corresponding parfile in parallel either immediately or at some later time, (j) completing the execution of the transformed parallel code segment, (k) capturing the output of each completed parfile execution, (l) replacing each parfile's corresponding unique marker tag in the output stream with its output, and (m) sending the entire output stream to the calling client.

### Parsing the PHP Application

The serial PHP web application can be transformed into a PHP web application that can run parts of its code simultaneously and still produce the same predictable output. The following discussion provides further explanation of the separation of the PHP application into serial code segments and parallel code segments during a parsing operation.

Consider a php application defined to be a folder branch of *.php files plus other support files, such as the GIF, JPG, and XML files. In order to transform some of the application to run in parallel, the files must be read and analyzed. Therefore, all php files in the folder are scanned recursively. For each php file encountered, the file is read and parsed into a mapping table. Parsing involves partitioning a stream of characters into a sequence of character segments called tokens. The php files are parsed into one large expression tree that can be analyzed for parallelism. The functions that can be parallelized are identified as parfuns. For each parfun, a parfile is created containing the parfun plus all required functions that are directly or indirectly called by the parfun. For each parfun in the main application, code is inserted at the beginning of the code block that can test at runtime whether it should run the function in serial mode or in parallel mode.

To illustrate the process of parsing, the application begins with an empty parsing stack and then pushes a new root token on this parsing stack. The token does not represent any actual parsing, but serves as a grouping parent token for all parsed tokens that follow. The tokens have the root token as their parent. The process iterates through all the tokens generated by a tokenizer, and processes each token according to reduction rules, such as Vaughan Pratt's algorithm to manage the production rules. Similar to a recursive descent algorithm, the process parses by top down operator precedence. As an example, assume a string “dist=speed*dt+x0” consisting of 22 characters where the first letter ‘d’ is index 0 in the string. The tokenizer breaks the string into the following tokens: “dist”, “=”, “speed”, “*”, “dt”, “+”, “x0”. Blank space and comments are skipped in the tokenizer. By descending through the tokens of an expression or statement, specific tokens are pushed onto the parsing stack. As expression boundaries are closed, expressions are popped from the stack much like a shunting yard algorithm. In the example above, the expression parse tree is given as:

```
=
    dist
    +
        *
            speed
            dt
        x0
```

Each parsed token has a starting index and stopping index, called a span, that refer to positions in the text file. The token “dist” has a span of [0:3] to denote that the token is parsed from position 0 to position 3 in the parsing text. Although tokens exclude blank space and comments, their positions are retained in the corresponding spans to permit cut-and-paste operations to directly transform source code, such as inserting code and wrapping function calls. Each token that arrives from the parsing stream updates the spanning boundaries of those tokens pushed on the stack. Every token is written in table 1 followed by the span in the format [a:b].

TABLE 1
Token span and stack

| Token (span) | Stack |
|---|---|
| dist [0:3] | dist [0:3] |
| = [5:5] | = [0:5] |
| speed [7:11] | = [0:11], speed [7:11] |
| * [13:13] | = [0:13], * [7:13] |
| dt [15:16] | = [0:16], * [7:16], dt [15:16] |
| + [18:18] | = [0:18], + [7:18] |
| x0 [20:21] | = [0:21], + [7:21], x0 [20:21] |

The first token encountered is the dist token, which has an initial span of [0:3]. The dist token is pushed onto the stack. The next token is “=” with an initial span of [5:5]. Since the “=” token has a higher precedence than the stack token, the “=” becomes evaluated to enforce the parsing rule that given any stack state, no token of higher precedence shall ever precede a token of lower precedence. The parser pops the higher precedence token from the stack first, appends the higher precedence to the children of the “=” token, uses its span value to widen the “=” token's span. The “=” token is pushed on the stack. When the span [a:b] is used to widen span [c:d], the resulting span is [min(a,c):max(b,d)]. For example, the span [5:9] widens the span [6:10] to give a span [5:10]. The resulting span is the smallest span that includes both span parameters.

Continuing with the illustration, the “speed” token is parsed to have a higher precedence than the “=” token so the “speed” token is pushed on the stack without evaluation. The “speed” token widens all the preceding tokens on the stack. The process continues to give the parse expression:

```
= [0:22]
dist [0:3]
+ [7:22]
    * [7:16]
        speed [7:11]
        dt [15:16]
    x0 [20:21]
```

Notice that every child's span is contained in all its parents' span, i.e., the “speed” token is contained in the “*” token which is contained in the “+” token which is contained in the “=” token. The span of the “=” token is characters 7 through 21, which yields the string segment “speed*dt+x0”. The entire left-hand part is added to the right-hand part. The assignment statement “=” is lower precedence than the “+” operator so it doesn't appear in the span. Such a parsing strategy can be expanded to handle all the operators, expressions, and statements of the PHP language. When function definitions are encountered, they are added to a table of function definitions. Given the span of the function, it becomes easy to wrap the entire function in an if-then statement.

When the application is completely parsed, the solution has a large parse tree that shows every file in the application as root nodes. Every root file node contains one child node for each function definition in that file. Every function definition node contains statement and expression nodes. Some of these nodes represent calls to other functions. A call graph is then created from the parse tree. The call graph allows the analysis phase determine which functions call which functions and vice versa. The call graph can show which global variables each function accesses, and whether the function reads or writes to the global variables.

### Parsing Analysis

Once all application files are parsed, the parse tables are analyzed for all functions that can be parallelized. Beginning with a set of all functions in the application, the functions that must be executed serially for one or more reasons, i.e., cannot be executed in parallel, are eliminated from the set. When finished, the functions that have not been eliminated will be all the functions that can be parallelized.

Each code segment or function is analyzed to determine which external shared resources the code segment accesses. For simplicity, only global variables are used as examples of shared resources. However, the same technique can be applied to database cells as well as external files. If the code segment writes to a global variable, then it is dismissed as not parallelizable. The reason is that in the dynamic nature of a PHP application, it is difficult to determine whether another function would read from that variable later or not. If the code segment only reads from that global variable, then the code segment is transformed into a parallelizable version, called a parfun. A parfun contains the exact lines of serial code before transformation, but adds header code that is executed at the beginning of each call to the function. The header code creates a unique object for this particular call that contains the original serial code and the value of every global variable that the function accesses. The object is sent to a scheduler for later execution. The parfun generates a unique call identifier tag string. Depending on the type of parfun determined during the analysis phase, the tag is either written to the output stream immediately, or it is returned to the caller as a function return value where the client is deemed responsible for sending the tag to the output stream. The unique marker tag represents code that needs to be executed at some later period before the final output is considered complete.

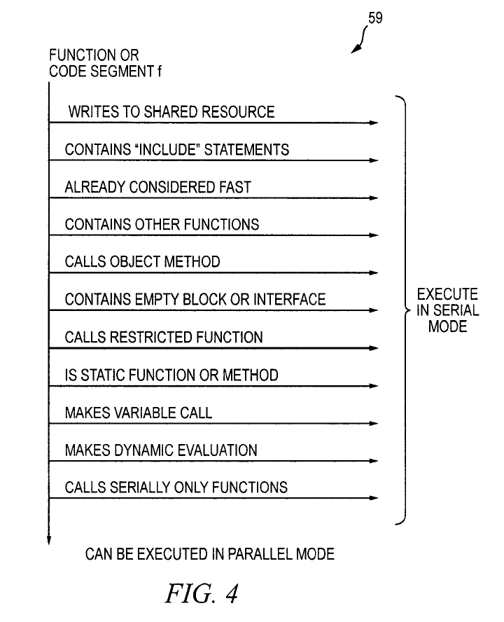

The determination of what functions must be executed serially and therefore eliminated involves a number of evaluations. FIG. 4 shows general guidelines 59 for determining when a function can be executed in parallel mode. Given a function, if it (a) writes to a shared resource, (b) contains an “include” statement, (c) is already considered fast, (d) contains other functions, (e) calls an object method, (f) contains an empty block or interface, (g) calls a restricted function, (h) is a static function or method, (i) makes a variable call (j) makes a dynamic evaluation, or (k) calls a serial only function, then the function should be executed in serial mode. If one or more of the above statements are true, then the function is executed in serial mode. Conversely, if all of the above statements are false, then the function can be executed in parallel mode.

In general, if a function writes to a shared resource, then all functions sharing that resource must be executed serially. In PHP, the above process must include functions that have reference parameters, since it is difficult to determine whether a reference parameter refers to a global variable or not. Consider the $GLOBALS array as a set of global declarations. For functions that contain exit calls, i.e., those that terminate the program, the functions can be removed from the set, or return a command to the main thread that the function is terminated. The main thread can then discard all outputs that occurred after the parfun is called. There are reasons that a function should terminate the entire application, e.g., credentials are invalid. If the function contains “include”, “include_once”, “require”, or “require_once”, then it cannot be parallelized because the act of including a file triggers execution of its code.

Fast functions should not be parallelized. A slow function is one that contains one or more of the following attributes: database calls, file operation, sleep, loops, such as for, foreach, while, and do while. Functions that contain other functions should not be parallelized, but rather should execute in the main thread. For simplicity, functions that contain method calls to objects should be removed from the set. Functions that have no code or empty blocks, such as interface and prototype definitions, should not be parallelized. Functions that make calls to restricted built-in functions should not be parallelized. Restricted functions modify the output buffer or the runtime environment. Functions that are methods should not be parallelized. However, in some cases, the entire object's state must be recreated in the parfile. Any changes to the state must be considered global in nature. Static functions should not be parallelized, because the static state of the function acts like a global variable. Functions that contain variable calls, e.g., “$X( )”, should not be parallelized because the actual name of the function to be called cannot be determined at compile time, and thus is not included in the parfile. Functions that make dynamic evaluations (e.g., calling the eval( ) function) cannot be parallelized.

If a candidate parfun, one in which the analysis is still trying to decide if it qualifies as parallelizable, calls a function that cannot be a parfun, then it is likely that the candidate parfun should not be parallelized. For example, suppose function f does not fail any of the anti-parallelization filters above, but it calls function g that writes to a global variable. Calling the function f has the effect of changing the value of the global variable, albeit indirectly. In this case, the function f should not be parallelized. On the other hand, suppose function g is a fast function that should not be parallelized. If the function f is considered a slow function but it calls a fast function g, then the function f can still be parallelized because the fast execution attribute does not propagate up the call chain.

When finished, all functions that cannot be parallelized are so marked and eliminated from the set of functions. What is left is the parfuns. Once the parfuns are determined, a parfile is created for each parfun. A parfile is a file that contains the parfun plus all other definitions (functions, classes, interfaces) that the parfun requires by traversing a spanning call tree for that parfun. In the case where two function definitions have the same function name, PHP does not allow both to be run simultaneously, but conditional code at runtime can determine which function definition gets called.

FIG. 5 illustrates PHP web application 60 separated into serial code segments and parallel code segments during the parsing operation. Assume the PHP web application has code segments or functions f1, f2, f3, f4, f5, and f6, representing a call graph of the functions. The entire PHP web application f1-f6 is evaluated to determine which portions of the code can be parallelized, i.e., transformed into a parallel code segment. The parsing analysis initially assumes all code segments may be transformable into parallel code segments. The parsing analysis evaluates code segments f1-f6 to determine which functions must be executed serially, i.e., cannot be transformed into parallel code segments for one reason or another under the guidelines of FIG. 4, and removes those essential serial code segments from consideration of being transformable into parallel code segments. At the conclusion of the parsing analysis operation, those portions of the code which have not been eliminated are viable for transformation into parallel code segments. In the present example, assume functions f1, f3, f5, and f6 are determined to be essential serial code segments and functions f2 and f4 can be transformed into parallel code segments, denoted by double lines adjacent to the functions. The parsing operation occurs during compilation time, so the executable code has serial code segments identified and parallel code segments identified. The parallel code segments can execute on multiple core processors simultaneously to reduce overall run time.

To set a baseline comparison, if all code segments were executed serially, then code segment f1 is executed first, followed by code segments f2, f3, f4, f3, f5, and f6, in that order. Code segment f3 appears in the serial execution stream twice because it is called twice; first by code segment f2 and later by code segment f4. A serial execution of the call graph resembles its spanning tree. If code segment f1 writes D1, f2 writes D2, f3 writes D3, f4 writes D4, f5 writes D5, and f6 writes D6, then the PHP standard output stream would contain “D1,D2,D3,D4,D3,D5,D6”, according to a serial execution of functions f1-f6 in FIG. 5.

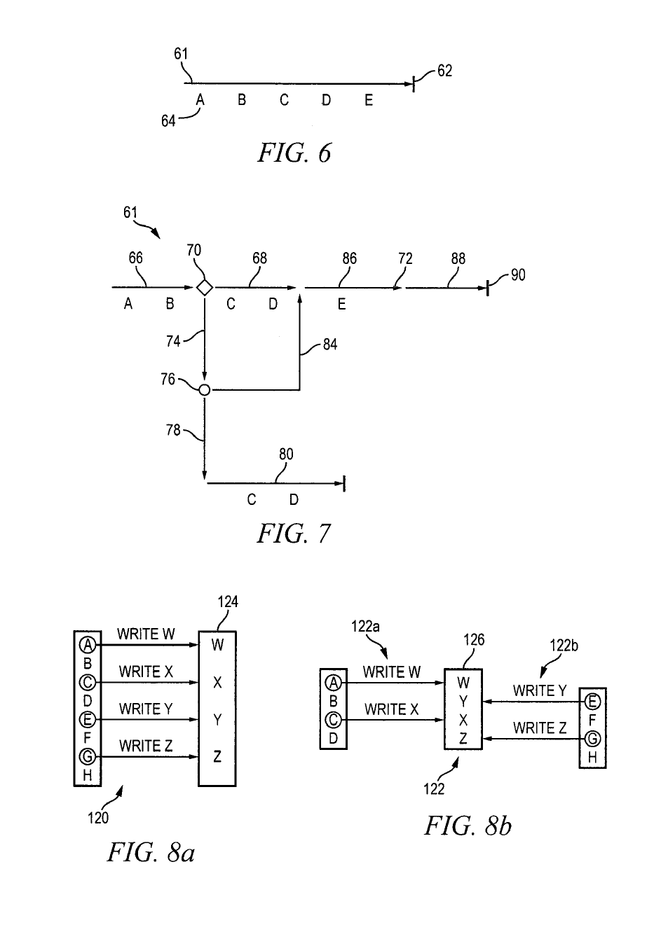

In another example, FIG. 6 shows PHP application 61 that represents a sequence of instructions that executes on a single thread to complete at point 62. During the execution, and at various instructions, characters 64 “A”, “B”, “C”, “D”, and “E” are sent to the output buffer. When the application finishes, the output buffer contains the string “ABCDE.” The characters A-E can represent HTML tags and blocks in a web application.

FIG. 7 shows the PHP application 61 of FIG. 6 transformed into one that can run on multiple threads of instructions simultaneously. After parsing the application and analyzing the results, code segment 68 is identified as a parfun that can run in parallel mode. As part of the transformation, header 70 is inserted into the code at the beginning of parfun 68. Header 70 is a conditional that, when certain runtime conditions dictate, captures the state of the global runtime upon entering parfun 68. A parfile 80 is created by copying all the components from code segment 68, as well as any other code needed to execute that section. There is always a one-to-one relation between parfun 68 and parfile 80. As implied, serial code segments run on the main serial thread, and parfiles run on remote parallel threads. A footer code 88 is created, after end 72 of application 61, to reduce or gather the output of parfile execution.

First, serial code segment 66 writes “AB” to the output buffer. Since the output buffer is initially empty, its content is “AB.” At header 70, parfun 68 (designed to output “CD”) saves its runtime state, writes a marker tag “T1” to reserve a position in the output stream to write an output value of parfile 80 when complete, and follows path 74 to branch 76. Branch 74 follows path 84 and returns to the end of parfun 68, effectively skipping code 68 altogether. The output buffer is now “AB,T1”. At branch 76, parfile 80 is scheduled for parallel execution by path 78 either locally or on a remote core processor. During the execution of parfile 80, the main thread continues executing serial code segment 86 which writes “E” to make the output buffer “AB,T1,E”. Parfile 80 eventually writes “CD” which is substituted for marker tag T1 in the output buffer by footer code 88. The output buffer now contains “ABCDE”. PHP application 61 terminates at point 90.

### Creating Parfiles

A parfile is a package or set containing a main function plus the supporting functions, modules, constants, and variable values that the main function needs to run without errors. The parfile executes a function of the main serial application in parallel on the main application. The parfile contains the code segment and all supporting components necessary execute the code segment. All components that the function requires to run must be included in the parfile, since logically it will be running in isolation from the application and all its resources. Before the parfile can run remotely, it must be deployed to the remote execution environment. The single file is a convenient package of deployment, but any type of deployable set is acceptable, e.g., assembly, JAR file, MSI, ZIP, or a custom solution, such as one that reads code from a database. The remote core processor receives the serial function, sets up its runtime environment at the time the main code skips its serial execution, calls the serial function in the parfile, and assumes responsibility that the function executes without an exception, such as a missing function error.

To determine the components to include in the parfile, the function is analyzed to see which functions it calls. The functions and required components are added to the parfile recursively. For example, suppose a function f1 calls function f2 and function f3. The function f2 calls the function f4 and the function f3 calls the functions f4 and function f5. Then the parfile must contain f1-f5.

If the main function, or any of its known dependent functions, use the eval statement or make indirect function calls, then the analysis cannot know for sure whether all supporting functions have been accounted for. Furthermore, the analysis cannot be sure that the main function will not eventually call a function that changes the global state of the runtime, a condition that should suppress parallelism. Thus, when dynamic execution is discovered in a function, that function, as well as all other functions that call it, should not be parallelized.

### Transformation of PHP Application

Continuing with FIG. 7, once all parfiles 80 have been created, the PHP application 66, 68, 86 must be modified to start these parfiles running in parallel at proper times so that the final output result will be the same as in serial mode. The application is transformed to associate a parfile with each parfun. In other words, each parfun 68 is transformed in the main application to have conditional branch 70, so that the function can be run in parfile 80 on some other thread or core processor. The code 68 in the main thread is skipped. The conditional branch can be implemented with an executable statement that is running in parallel, then write the marker tag and return to the main thread without executing parfun 68. The parallel code segment is executed through the associated parfile 80 on a remote core processor.

There are two methods to transform code to be parallelizable: (1) wrap the calls to a function; or (2) wrap the code of a function declaration. The second option has advantages because there can be many calls to a function, but only one function definition. In addition, with the ability of a PHP application to evolve dynamically via plug-ins, it becomes mandatory with the first option to retransform the entire application each time the code changes. With the second option, it is not a requirement because all function calls need not be accounted for. Wrapping the code means determining the parts that can be skipped at runtime. A function call can be implicit, while a function definition must be explicit. By wrapping the code of a function definition, any part of the code can be wrapped. In other words, all code need not be wrapped in a function. Wrapping may involve inserting a header and footer around the code to be wrapped, e.g., using a try-catch-finally block to guarantee that the footer is called even when “return” statements are encountered or exceptions occur.

In the following PHP code, the function f calls function g. The parfile contains both the function f definition and the function g definition.

```
function g( )
{
    ...
}
function f( )
{
    ...
    g( );
    ...
}
```

Suppose that both functions are parallelizable. At runtime, any call “f ( )” executes the serial code in the definition instead of the parallel code in the parfile. But the goal is to run the parallel code in the corresponding parfile instead. Therefore, the serial definitions are modified so that the code in the parfiles are executed instead by inserting the following three lines of code at the beginning of each function definition:

$a=func_get_args( );

$r=run(PARFILEID, $a, READS, WRITES, 0);

if ($r !==NORIP) return $r;

The main application code then becomes:

```
function g( )
{
    $a = func_get_args( );
    $r = run(PARFILEID, $a, READS, WRITES, 0);
    if ($r !== NORIP) return $r;
    ...
}
function f( )
{
    $a = func_get_args( );
    $r = run(PARFILEID, $a, READS, WRITES, 0);
    if ($r !== NORIP) return $r;
    ...
    g( );
    ...
}
```

The first line gets all the arguments passed into the function via the func_get_args function. In this case, neither the function f nor the function g contains function parameters, but if they did, an array of key=>values would be created in $a. The second line calls a library function “run” which is included at the top of the code as part of the parallelization library. The run function takes the PARFILEID which is inserted at transformation time to uniquely identify the parfile, the set of function parameters $a, a list of name/value pairs for all global variables that the function f reads from directly or indirectly, and a list of all name/value pairs for all global variables that the function f writes to directly or indirectly. The parameters are generated at transformation time and remain constant thereafter.

The run call checks to see if the function f or function g should be run in parallel. A function may not be run in parallel if the function should only run when there is high demand for the website, or the website is fast enough that parallelizing has minimal benefit. In other cases, the remote worker servers, where the parfile should run, may be offline for maintenance. The user may have temporarily disabled parallelism. Although the parser assumes that the function is slow, e.g., a sleep( ) statement, the runtime supervisor program determines that statistically the function is really fast, e.g., a sleep(0) statement. The supervisor keeps track of the times needed to run the application in parallel or serial mode. The supervisor performs analysis over the course of many hits to automatically optimize the actual parallelization runs of the application. If the run call determines that the function should not run in parallel, it returns the NORIP constant value, which is a value that is statistically unlikely to be returned from the actual serial part of the code that follows, e.g., a randomly generated string of 100 characters. It simply serves as a marker not to run in parallel. By returning the value, the “if” statement does not return, but rather falls through to the serial code. No parfile is run.

If the run call determines that the function should run in parallel, it starts the corresponding parfile running in the background and returns a unique marker string. The string represents the place in the output stream where the code in the function f would generate an actual output, i.e., the position in the execution file that the function is called. Every call to the run function returns a unique string, even if the same parfun is called, which causes the function f code to return immediately. The background process can be web process threads, forked process (POPEN), remote server, parfile sent via socket connection or hyper-threading across multiple cores.

In all these scenarios, the parfile is sent to a PHP executor that compiles the files for execution. While executing, the call to run the parfile in parallel returns immediately, which causes the run function to return a marker immediately, or write one to the output stream if the function f does not return values, and then cause the function f to return. The function f is set to run in parallel by starting the parfile for the function f running in the background and then bypassing the serial code in its application definition.

To be executed, a parfun execution instance must be created dynamically at runtime when the run function is called. The parfile is read into an instance string. A snapshot of all global variables (name/value) pairs is created and inserted as code at the top of the instance string. The PHP code sets the global variable state on the remote process where the parfile executes. A call to the main function is inserted at the end of the instance string, containing the values of the parameters that are passed into the run function at the time it is called. In addition, for certain types of parameters that represent objects of specific classes, e.g., wpdb, the actual class definition is inserted into the instance string as a requirement to de-serialize the object's state.

A parallel return (parret) is a parfun that returns a value; i.e., a parallel returning function, i.e., functions that return values, shown as follows:

```
function f(...)
{
    ...
    return $x;
}
```

If the caller uses the value that it returns, that in effect is a dependency, the call must wait for function to finish before it can use the value returned. The requirement to finish before returning a value negates the benefits of running in parallel. However, if the caller does not transform the output, then the parret can run in parallel. An example of transforming the value is an expression that reads the output value. In the examples below, the first expression stores the return value. The transformation blocks parallelism because of the inability to predict the stored value. The second method assumes that the return is a number and performs an addition. If parallelized, the run statement would return a string marker—not a number, and cause a runtime error. The third method calculates the length of the string. Again, if run in parallel, the length of the marker string would be calculated instead of the assumed value, which would likely cause a logical error that makes the output of the application running in parallel look differently than when run serially. Finally, by using the return value in a statement that reads the value prevents parallelism.

$x = f( )
f( ) + 3
strlen(f( ))
if (f( )) {...}

Examples of reading the output value that do not prevent parallelism are “echo f( )” and “echo f( ). there”. In both these cases, directly writing the return value to the output stream is fine because the marker is not used in an unexpected manner nor transformed. In the second case, the concatenation operator is not considered a transformation and consequently does not prevent parallelism. For parrets, it is the responsibility of the caller to tell the parret that the caller will not transform the value by wrapping all parret calls with a run-in-parallel call, referred to as a rip call. The rip call wraps the parret call so that header and footer code can be called before and after parret call. Given the code:

echo f( ). “there”

After wrapping the call, the code is transformed to:

echo rip(‘f’, array( )). “there”

The rip call sets a flag that the function f is to run in parallel. If a plug-in is added that makes a later call to the function f, that call will not automatically be wrapped in a rip call, so the function will not run in parallel.

### Execution of PHP Application

A transformed PHP application transforms some of the code into parallel code with the rest of the code remaining in its serial form. When a transformed PHP application is executed by a client requesting a webpage, the transformed application as a whole begins execution serially as it did before transformation. However, when the application calls a parfun the header code at the beginning executes first. The code determines whether the parfun should or should not run in parallel. One reason why the execution might not want to run a parfun in parallel is that statistically, the parfun has been determined to run slower in parallel than serially. There is a small amount of overhead time needed to start a parfun running in parallel. If this time exceeds the actual serial execution, then it becomes a disadvantage to run the function in parallel. Such decision data can only be determined at runtime over many execution scenarios where the serial execution time is empirically compared to the parallel execution time. The header code in each parfun keeps track of its corresponding statistical execution time to build a long-term profile so that the entire parallel execution environment becomes automatically and dynamically tunable for optimization.

If the parfun header determines that the code should run serially, it falls through to the original unaltered serial that follows. If, however, the parfun header determines that the code should run in parallel, the header creates the unique marker tag for the parallel execution, saves the state of all global variables seen by the serial code, starts the serial code running in the background on another thread or in another process, and then either writes the marker tag to the output stream and return, or returns the tag as the function's return value. The marker tag reserves a position in the output stream to write an output value of the parfile when complete. In either case, the serial code that follows is skipped completely. The application runs serially from start to finish, but just runs faster because much of its internal code (the parfuns) were skipped; in effect shortening the execution time. But when the serial portion of the code finishes skipping all the parallel portions of the code, and executes the last statement, the output stream contains the same bytes as the serial execution except for the string segments that would have been created if all the parfuns were not skipped. These string segments are instead unique tags that act as placeholders to be replaced with actual output later. But the incomplete output has not yet been transmitted back to the client for rendering. PHP, like many procedural languages, have the ability to capture the output into a buffer and then send when ready.

When the transformed application finishes running its original serial code, excluding the code skipped by each parfun, the transformed application then proceeds to gather all the outputs of each executing parfile as it completes. When a parfile completes, its output is captured and returned to the main execution thread where it is substituted in place of its unique marker tag into the output stream.

In another implementation, when a parfun header skips the serial code, the unique tag is written to the output stream but the serial code is not started in the background on another thread. The unique tags instead become empty HTML <SPAN> tags whose “id” attribute is the unique identifier. The entire output stream is immediately sent back to the browser for rendering. The HTML looks exactly like it did before but with missing content. To give the user the impression that content is loading, the SPAN tag could look like this: “<SPAN id=‘SOMEUNIQUEIDENTIFIER’>Loading . . . </SPAN>” where the browser will render the tag as a label that reads “Loading . . . ”. In this implementation, the transformed web application injects javascript that runs immediately on the client. The javascript scans through the entire document object model (DOM) and makes an inventory of all SPAN tags that represent incomplete content. The javascript then sends these tags back to the server in a second call, or which may be in the form of an HTTP5 web socket call. The server finds the corresponding parfiles for each identifier received and starts each running. The server returns the content of each parfile as it completes as a serial stream back to the client, which substitutes the content into the corresponding SPAN tag located by using the “id” attribute. In this implementation, the user sees the incomplete scaffolding HTML along with advertisements early while remaining parfile content eventually appears as it completes.

When the PHP application from FIG. 4 is executed in parallel mode, the principal execution thread executes code segment f1 which writes D1 to the PHP standard output stream and returns. The output stream contains “D1.” Next, the principal execution thread executes code segment f2. Since code segment f2 is a parfun, the principal execution thread writes marker tag T1 to the output stream and returns without further execution. Instead, parfile f2 is routed to another core processor for parallel execution. The parfile f2 containing code segments f2 and f3 executes on another core processor in parallel with the principal execution thread. The output of parfile f2 is reserved in the output stream by tag T1. The output stream now contains “D1,T1.” Next, since code segments f2 and f3 are being handled on another core processor, the principal execution thread executes code segment f4. Since segment f4 is a parfun, the principal execution thread writes marker tag T2 to the output stream and returns without further execution. This skips the calls to f3 and f5 that f4 makes during its normal execution. Instead, parfile f4 is routed to another core processor for parallel execution. The parfile f4 containing code segments f3, f4, and f5 executes on another core processor in parallel with the principal execution thread. The output of parfile f4 is reserved in the output stream by tag T2. The output stream now contains “D1,T1,T2.” Next, since code segments f3, f4, and f5 are being handled on another core processor, the principal execution thread executes code segment f6 which writes D6 to the PHP standard output stream and returns. Parfiles f2 and f4 are running simultaneously (in parallel) with f6. The output stream contains “D1,T1,T2,D6.”

One cannot predict which parfile f2 or f4 will complete first, but the transformation process can run them both simultaneously because it does not matter which completes first; only that they both complete eventually. Suppose f4 completes before f2. When parfile f4 completes execution, it returns values from the execution of code segments f3, f4, and f5. In this case, code segment f4 writes D4, code segment f3 writes D3, and code segment f5 writes D5. The output buffer of the process running parfile f4 becomes “D4,D3,D5”. The output buffer is read by the main execution thread and then substituted for tag T2 in the output stream. The output stream now contains “D1,T1,D4,D3,D5,D6.” When parfile f2 completes execution, it returns values from the execution of code segments f2 and f3. In this case, code segment f2 writes D2 and code segment f3 writes D3. The process running parfile f2 becomes “D2,D3”, which is read from the main thread and substituted for tag T1 in the output stream. The output stream now contains “D1,D2,D3,D4,D3,D5,D6”, which is the same output stream as if all code functions f1-f6 had executed serially.

FIGS. 8a-8b illustrate writing in a serial code segment 120 and writing in a parallel code segment 122. FIG. 8a is a simplified view of the serial operation of the PHP code. In FIG. 8a, instructions A to H in serial code segment 120 produces four write operations. The write operations are stored in output 124, which can be memory, file, display, or network connection. In serial code segment 120, instruction A writes W to output 124, instruction C writes X to output 124, instruction E writes Y to output 124, and instruction G writes to output 124, each one after the other in a sequential manner.

FIG. 8b illustrates the same instructions as FIG. 8a writing in parallel code segments 122a and 122b to execute simultaneously for faster operation. The instruction A and instruction C in parallel code segment 122a execute at the same time as instruction E and instruction G in parallel code segment 122b. That is, instruction A writes W to output 126 and instruction C writes X to output 126, while instruction E writes Y to output 126 and instruction G writes Z to output 126. The output 126 is shown to contain “WYXZ” after the execution of parallel programs 122a and 122b, although the output could have been “WYXZ”, “YWXZ”, “YWZX”, and “YWXZ”, depending on the execution timing of instructions A-H. All that is guaranteed is that W comes before X, and Y comes before Z because each code segment 122a-122b executes by its own thread. In any case, by nature of the parallel execution of programs 122a-122b output 126 does not necessarily match output 124 generated by serial processing. Output 126 must be re-organized to match the proper serial ordering.

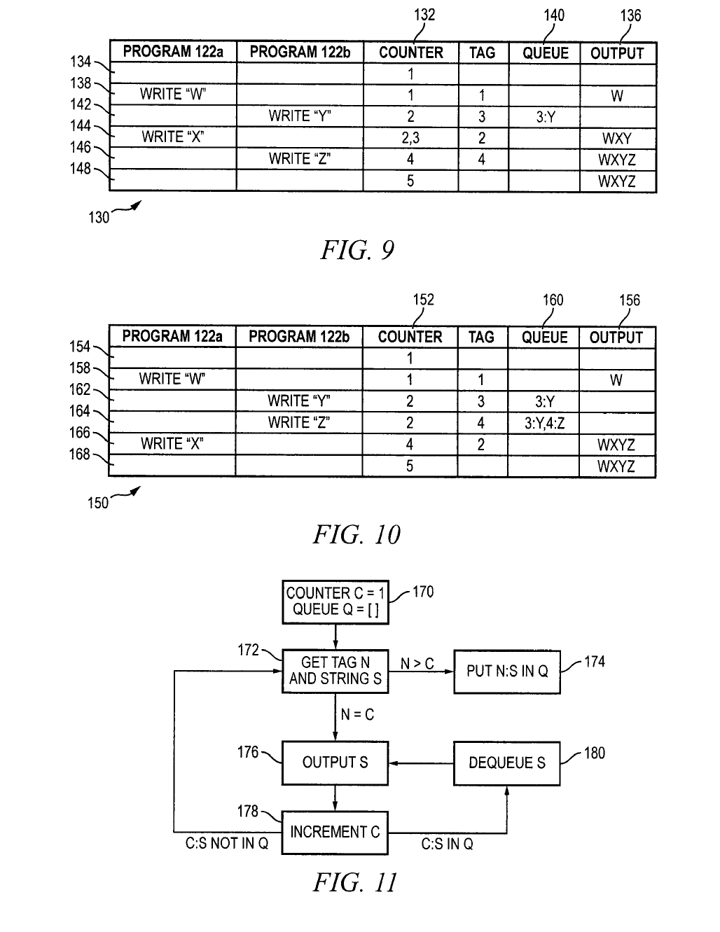

FIG. 9 shows another embodiment of handling marker tags for parallel code segments 122a and 122b. State flow diagram 130 shows parallel code segments 122a and 122b executing asynchronously. Counter 132 is set to value 1 in initial state 134. The value of counter 132 denotes the expected next marker tag to be sent to output 136. Assume instruction A in parallel code segment 122a finishes first, i.e., ahead of instruction E in parallel code segment 122b. In state 138, instruction A writes “W”, which has been previously tagged with 1 to denote the first logical output. Since the tag 1 matches the counter value of 1, the “W” is sent to output 136. Counter 132 is incremented to value 2 to indicate that output 136 is ready for the second logical output. Counter 132 increments when the next logical output, as indicated by the count value, is received. Since the second logical output has not been completed and is not waiting in priority queue 140, nothing is written to output 136. In state 142, instruction E in parallel code segment 122b writes “Y”, which has been previously tagged with 3 to denote the third logical output. The tag 3 does not match the counter value of 2. In other words, output 136 is ready for the second logical output, which has not arrived. The third logical output has arrived but output 136 is not ready for the third logical output. Therefore, the pair 3:Y is placed in the queue 140. In state 144, instruction C in parallel code segment 122a writes “X”, which has been previously tagged with 2 to denote the second logical output. Since the tag 2 matches counter value 2, the “X” is sent to output 136, which now contains “WX”. Counter 132 is incremented to value 3 to indicate that output 136 is ready for the third logical output. Since queue 140 contains the pair 3:Y which matches the counter value 3, the “Y” is written to output 136, which now contains “WXY”. Counter 132 is incremented to value 4 to indicate that output 136 is ready for the fourth logical output. Since the fourth logical output has not been completed and is not waiting in queue 140, nothing is written to output 136. In state 146, instruction G in parallel code segment 122b writes “Z”, which has been previously tagged with 4 to denote the fourth logical output. The tag 4 matches the counter value 4 so the “Z” is sent to output 136, which contains the reconstructed string “WXYZ.” In state 148, counter 132 is incremented to a value of 5. Since instruction outputs have been written to output 136 (the counter value is greater than the number of expected outputs) and queue 140 is empty, the parallel programs 122a and 122b terminate.

FIG. 10 shows a state flow diagram 150 of another embodiment with parallel programs 122a and 122b executing instructions asynchronously in a different merge order. Counter 152 is set to value 1 in initial state 154. The value of counter 152 denotes the expected next marker tag to be sent to output 156. Assume instruction A in parallel code segment 122a finishes first, i.e., ahead of instruction E in parallel code segment 122b. In state 158, instruction A writes “W”, which has been previously tagged with 1 to denote the first logical output. Since the tag 1 matches the counter value of 1, the “W” is sent to output 156. Counter 152 is incremented to value 2 to indicate that output 156 is ready for the second logical output. Counter 152 increments when the next logical output, as indicated by the count value, is received. Since the second logical output has not been completed and is not waiting in priority queue 160, nothing is written to output 156. In state 162, instruction E in parallel code segment 122b writes “Y”, which has been previously tagged with 3 to denote the third logical output. The tag 3 does not match the counter value of 2. In other words, output 156 is ready for the second logical output, which has not arrived. The third logical output has arrived but output 156 is not ready for the third logical output. Therefore, the pair 3:Y is placed in the queue 160. In state 164, instruction G in parallel code segment 122b writes “Z”, which has been previously tagged with 4 to denote the fourth logical output. The tag 4 does not match counter value 2. In other words, output 156 is ready for the second logical output, which has not arrived. The fourth logical output has arrived but output 156 is not ready for the fourth logical output. Therefore, the pair 4:Z is added to queue 160. Queue 160 now contains the parts 3:Y and 4:Z. Parallel code segment 122b terminates because it has processed the last instruction. In state 166, instruction C in parallel code segment 122a writes “X”, which has been previously tagged with 2 to denote the second logical output. The tag 2 matches the counter value 2 so the “X” is sent to output 156. Counter 152 is incremented to value 3 to indicate that output 156 is ready for the third logical output. Since queue 160 contains the pair 3:Y which matches the counter value 3, the “Y” is written to output 156. Counter 152 is incremented to value 4 to indicate that output 156 is ready for the fourth logical output. Since queue 160 contains the pair 4:Z which matches the counter value 4, the “Z” is written to output 136, which now contains the reconstructed string “WXYZ”. In state 168, counter 152 is incremented to a value of 5. Since instruction outputs have been written to output 156 (the counter value is greater than the number of expected outputs) and queue 160 is empty, the parallel code segment 122a terminates.

FIG. 11 shows the generalized process for ordering the tagged outputs of multiple parallel programs executing asynchronously. In step 170, counter C is initialized with the value of 1. The priority queue Q is empty. The priority queue is a holding set and can be implemented as a dictionary with tag integer keys and printed strings as associated values. In step 172, the next write string S waits tagged with an ordering number N. Step 172 can be implemented as an object method called externally, or as an output filter callback; e.g., the PHP function ob_start(callback). If an output is received that has arrived ahead of its time, then N is greater than C and process flow goes to 174. The key/value N:S is placed in the queue Q. If N is equal to C then the string S is ready to be sent to the output in step 176. Counter C is incremented to the next value in step 178. If a key C:S exists in queue Q, then de-queue the key as S in step 180 and send to the output. If no key is found in queue Q, then return to step 172 and wait for the next string.

Parallelizing a streaming programming language adheres to the following architectural rules. Each parallel code segment of the transformed serial application should run in its own process. The PHP.EXE interpreter is already capable of handling serial code segments. The transformation involves slicing the serial code into multiple code segments so that each can run simultaneously across multiple core processors. The main application, which makes parallel calls to the remote processes, executes on the main web server handling the request. The execution of the transformed code segment determines at runtime which workers are available to execute functions. Each web request is evaluated by a distributed resource manager (DRM). The DRM periodically polls the status of the workers to determine their utilization and availability. The DRM is a web service returning a cached XML document that is periodically regenerated by a background process.

The execution of the transformed application creates a profile of which parallel code segments are slow and could benefit from parallel execution. A low-resolution profiler can be built into the transformed application for every code segment determined to be parallelizable. The profiling state must be persisted with the code. To allow for web farms, a common server is used. However, some PHP web applications might not have access to a database. Therefore, the DRM publishes a web service that can store and retrieve profiling times for a given application. Since the same application might run simultaneously for multiple concurrent web requests, the DRM is able to combine profiling times from different runs into a running statistical average. Since profiling every function and module is time consuming, the transformation selects functions and modules that are suspected to be slow, such as those that make calls to database functions, web services, and other external I/O transfers. Functions that access the disk are not considered for parallelization because these disk files would need to be distributed. The final implementation may also choose not to parallelize instructions that make implicit calls; i.e., calls to functions whose names are stored in variables.

### Additional Considerations

PHP generates HTML dynamically at runtime based on GET and POST parameters submitted by the local browser. There must be a method to undo any transformation in the event that a bug is found in the transformation. The transformed code should be stored in a separate file, preferably a different folder. In this case, the original web application folder is swapped out with the new transformed folder, which likely contains a similar set of files with some or all transformed to run in parallel whenever possible. Additional files may be added as well. Swapping the folder back performs the undo operation.

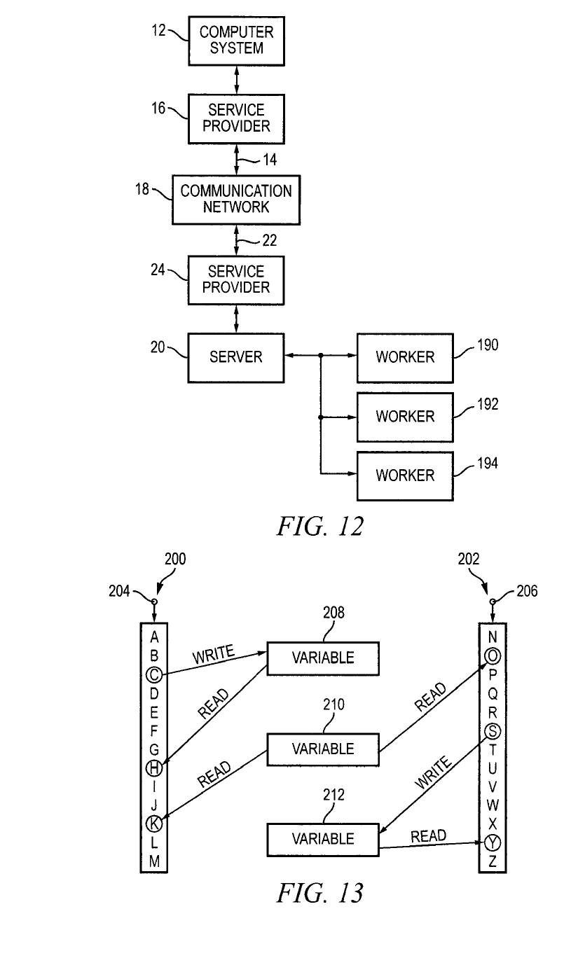

Parallel code must be capable of running on other processors called workers. FIG. 12 shows workers 190, 192, and 194 connected to server 20 within electronic communication network 10. Workers 190-194 are able to receive jobs from server 20 to parallel process segments of the PHP code. The number of workers is variable at all times including application execution. The number of workers available to run parts of the PHP application in parallel might be zero, one, or more. For example, ten workers may be available at the start but if one fails the job must be run on another processor. If the number of available workers is one at the start and the one worker fails, and no more workers are available, the job must be re-run serially in the main client process.

Code to be run on other core processors must first be deployed to the available cores. As long as the code does not change, this is a one-time operation. However, the first time a code segment is deployed to another core processor, the main client may run slower as measured at runtime. In order to optimize the runtime, each core processor must be evaluated to check whether the core processor already has code and then conditionally deploy to the code segment if the core is available. In addition, the time that a worker needs to initialize the parallel code segment must be considered.

At the end of the process, the outputs from the parfiles running in the background must be pulled together. The markers in the output stream are replaced with the return values. In the main application, the function f is called and later the function g is called, both set to run in the background. Then two markers are written to the output stream, which is buffered by using the ob_start( ) function built into PHP. At the end of the main application, a loop begins running that polls for the next parfile to complete, takes the output from that completed parfile and substitutes it in for the corresponding marker in the output stream, and repeats until all parfiles are finished running or some timeout expires. When all parfiles complete, the entire buffered output stream returns to the local browser to generate website 26.

As previously mentioned, the main PHP application thread starts the parfiles running in the background, and then at the end waits for the parfiles to finish. As each parfile finishes, each corresponding output is substituted for the markers in the output stream. When all parfiles finish, the entire output stream is sent back to the local browser. However, instead of returning a random “run” marker in the output stream at the end of the main PHP application, an HTML <SPAN> tag is returned that contains the running instances information. The entire output HTML can be returned immediately to the browser while parfiles are still running in the background on the server. The SPAN tags contain the text “LOADING . . . ” so that the webpage shows activity.

All unresolved SPAN tags are put into a packet and the web server is queried for the outputs of the running parfiles. The web server looks to see if any of the parfiles queried in the packet have finished running. If any finish, their outputs are returned to the javascript, which renders it in place of their corresponding “LOADING . . . ” text, and then the javascript queries the web server for the remaining unresolved SPAN tags. The process repeats until all SPAN tags are resolved, or a timeout occurs. The SPAN tags contain a unique identifier of the running parfile instance, which is used to synchronize responses with the actual SPAN tag, the identifier parfile that is executed, the snapshot of the global state at the time the main application's parfile is called, and host/port of the remote worker server. With the exception of the identifier, which is just a random one-time identifier, the remaining parameters are encrypted with a password that is only known on the server side for security.

Connection affinity may affect the ability of the javascript to call back to the same server, which typically happens when web servers are load balanced or farmed across a single IP address. To resolve the issue, the SPAN tag can contain the location of the running instance that spans servers, and also contains the parfile instance, which is sent back to the server and executed on its own connection thread. A distributed resource manager can also resolve the location of running instances that are not found on the web server that is polled.

To automatically parallelize streaming programming languages, (1) begin with a folder branch of application files written serially in a given language, (2) parse all the application files according to the grammar of the language, (3) create a dependency map between functions and modules based on function calls, includes, and variable access, (4) search for branches of appropriate sizes deemed optimal for parallelization, and (5) transform those branches into code that takes a snapshot of the current state of the global environment at the time the code is run. Normally, a function that can be run in parallel will normally be run at a certain time in the application's lifetime. When executed in parallel, the code runs at the same place in the application, but it returns immediately leaving a unique place holder in the output stream to mark where the output of that code should go. The place holder or marker can be a <SPAN> tag that can be immediately returned to the browser for rendering, but with javascript periodically polling the server for completion of the code. When the application runs the parallel code, the current values of the required global variables are recorded at that point in time. The code is submitted to a parallel processor. At that point, a single PHP script contains the parallelizable function, all the functions that it requires, and all global variables that it needs to generate an output for that point in time. The values of the global variables are encoded as PHP declarations so that they travel with the code.

The transformation works on an existing application, which is a set of one or more files organized into a folder branch. The transformation cannot just recursively parse the files in a spanning tree starting from the main application file. It is not possible to know which files are included since the “include” statement can be parameterized. The code files found in an application must be parsed regardless of whether some are not used. Since PHP is a serial language, it is actually easier to find code dependencies in PHP, than in languages that allow threads. All places in the code that change the state of the system; i.e., write to storage, are identified with particular focus on the function and module boundaries. PHP functions are not required to return values.

All programming languages have instructions that manipulate storage, which involves setting the value of a variable or flag, performing some operation that changes a status register, and writing to a file, a database, or some other external I/O device. All these methods are grouped together as write operations to some store. The languages also have the ability to read these values. Variable values can be tested, files can be read, and databases can be queried.

FIG. 13 shows two independent code boundaries 200 and 202. Each independent code boundary contains a set of instructions with an entry point 204 and 206. Code boundary 200 has instructions denoted A to M, and code boundary 202 has instructions N to Z. The instructions may loop or skip. The instructions can represent computer readable instructions, byte code instructions, language statements, function calls, or even blocks of code.

Independent code boundaries can be executed simultaneously with no coordination. Two code boundaries are said to be independent if neither writes to any location that the other one reads. In FIG. 13, a first code boundary is said to depend on a second code boundary if the second one writes to a store that the first one reads from. Reading from the output stream is not a typical operation. Writing to the output stream, e.g., echo, print, and printf, has the same effect as writing to a variable but the order in which values are written to the output stream is significant. The order of output must be maintained for both the serial application and the parallel transformed application. It is a logical requirement that both must produce the same output, which means the same order.

Assume the application first calls code boundary 200 and second calls code boundary 202. The execution begins with instruction A and terminates with instruction Z. Assuming no loops or skips in the code, twenty-six instructions are executed. If each instruction takes the same unit of time to execute, then the application executes from start to finish in twenty-six units of time.

During the execution phase, instruction C writes to variable 208, instruction H reads from variable 208, instruction K and instruction O reads from variable 210, and instruction S writes to variable 212, and instruction Y reads from variable 212. Since neither code boundary 200-202 writes to a variable read by the other, both can be parallelized. Both code boundaries 200 and 202 read from the same variable 210, but that event does not cause a dependency which could prohibit parallelizing.

When code blocks execute in parallel, each block running simultaneously can write to the output stream. If left alone, the outputs of each block would be merged into each other and not resemble the output that is produced by the serial execution. To make the output of the serial application and the parallel application match, the parallel application must tag the outputs with integer numbers and intercept the output stream with a filter. The filter would only send the output if all outputs with lesser integer tags have been sent. Otherwise, the filter delays the output by placing it in a priority queue. A counter is maintained by the priority queue to determine which output tag is expected to be written to the actual output stream. When the filter gets that output, it is sent on through to the actual output and all successor outputs found in the queue are sent as well. Otherwise, it is placed in the queue. Part of the transformation process is to insert integer counters into the output stream so that an output filter can order the data properly.

The following code segment defines two function definitions with the same name, f, but only one is executed at runtime.

```
if ($x)
{
    function f( ) {...}
}
else
{
    function f( ) {...}
}
```

Which function definition gets declared must be determined at runtime. Each function definition in the main application is preceded with code that declares which definition is executed at runtime. The above code becomes:

if ($x)
{
def(’F’, THISID);
function f( ) {...}
}
else
{
def(’F’, THATID);
function f( ) {...}
}

The parallelizing library associates the function definition id at runtime. When the actual execution is called, a global state variable becomes set and appended to the parfile execution instance that tells the parfile which definition to activate. The parfile must have both function definitions for the function f stored and wrapped with conditionals. The parfile becomes:

if ($GLOBALS[’defs’][’f’] == THISID)
{
function f( ) {...}
}
if ($GLOBALS[’defs’][’f’] == THATID)
{
function f( ) {...}
}
f( );

When the main thread runs, it makes calls to the existing definitions of the parfuns, which contain serial code. The parfun definitions in the main application are modified so that at runtime, the actual code is bypassed and the parfile is called instead. A condition statement is inserted at the beginning of each parfun definition. For example, if the code segment is executing in parallel then return. The code determines at runtime whether the function should return immediately to be executed elsewhere in parallel, or fall through into the actual function block of statements.

### Commercial Applications

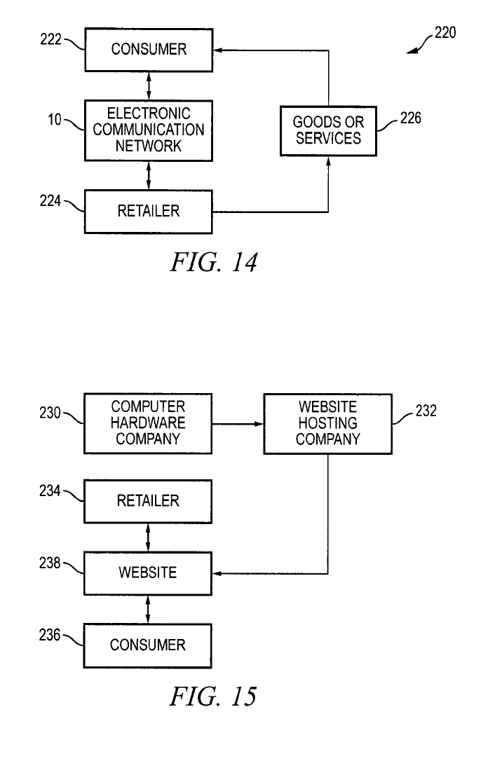

FIG. 14 shows activity within commerce system 220, including consumer 222 interacting with retailer 224 through electronic communication network 10. In particular, consumer 222 is able to acquire goods or services from retailer 224 using electronic communication network 10. Consumer 222 accesses the website of retailer 224 generated with PHP and selects one or more goods or services available on the website for purchase. Consumer 222 provides payment and shipping information to retailer 224 through the website. Retailer 224 ships goods or services 226 to consumer 222 to complete the transaction. The speed of operation of the commercial transaction is controlled by parallelizing the PHP website. The information related to the commercial good or service is made available via the parallelized website maintained by retailer 224. Consumer 222 can make the purchasing decision and complete the commercial transaction. The parallelized PHP code thus controls the speed of operation of the commercial transaction within commerce system 220.

FIG. 15 shows another commercial application with computer hardware company 230, e.g., selling core processors, licensing the code transformation technology to hosting company 232. Hosting company 232 hosts websites for a number of retailers 234. Computer hardware company 230 can control the commerce between consumer 236 and retailer 234 by controlling the speed of operation of website 238 hosted by hosting company 232 under the license agreement. Indeed, computer hardware company 230 can offer faster execution of website 238 to retailers 234 and consumers 236 using core processors made and sold by the computer hardware company. In addition, hosting company 232 can control the commerce between consumer 236 and retailer 234 by controlling the speed of operation of website 238. For example, hosting company can allow website 238 to execute faster if retailer 234 places banner ads 28 on website 26. The banner ad 28 can be displayed on computer system 12 during execution of the parfile.

The benefits of the transformation can also be tied to other platforms besides a computer hardware company, such as companies that provide the following client and server side products and services: operating systems, cloud and managed hosting, advertising, search, routers, smart phones, browsers, mobile internet devices, desktops, servers, laptops, netbooks, and tablets. As an example of tying the benefits of the transformation to a platform, consider consumer 236 hitting a transformed website 238 using a smartphone manufactured by a computer hardware company 230. When the website 238 detects the consumer's use computer hardware company's 230 brand of smartphone, the website skips more or all parfuns to increase parallelism and reduce website 238 load times to give a marketing advantage to the computer hardware company 230—faster web access for its devices.

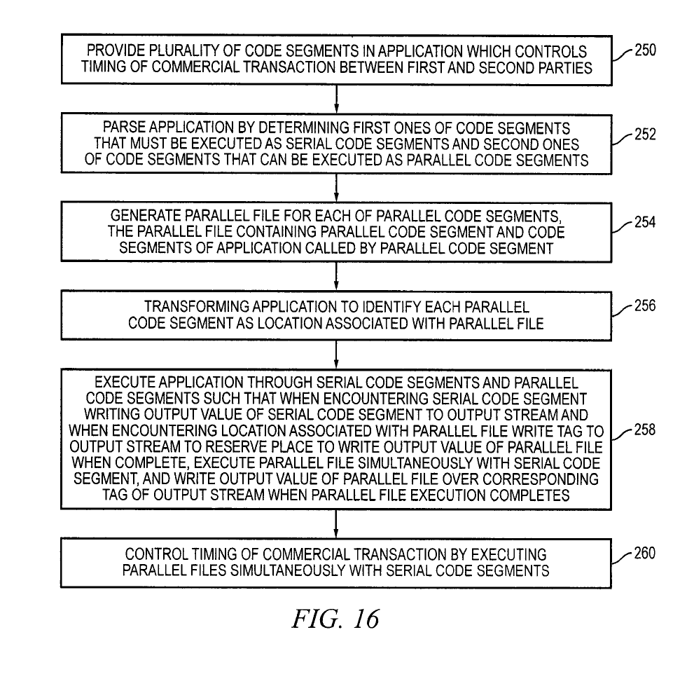

In summary, FIG. 16 illustrates a method of controlling timing of a commerce transaction by transforming serial code segments into parallel code segments. In step 250, a plurality of code segments in an application controls timing of a commercial transaction between first and second parties. In step 252, the application is parsed by determining first ones of the code segments that must be executed as serial code segments and second ones of the code segments that can be executed as parallel code segments. Parsing the application involves determining a first code segment that must be executed as a first serial code segment because the first code segment writes to a variable and a second code segment reads from the variable. The parallel code segments includes the code segments of the application less the code segments that must be executed as serial code segments. In step 254, a parallel file is generated for each of the parallel code segments. The parallel file contains the parallel code segment and the code segments of the application called by the parallel code segment. In step 256, the application is transformed to associate each parallel file with the parallel code segment. In step 258, the application is executed through the serial code segments and parallel code segments such that when encountering the serial code segment writing an output value of the serial code segment to an output stream and when encountering the location associated with the parallel file writing a tag to the output stream to reserve a position in the output stream to write an output value of the parallel file when complete, executing the parallel file simultaneously with the serial code segment, and writing the output value of the parallel file in the reserved position of the output stream when the parallel file execution completes. The serial code segments are executed on a local core processor, and the parallel file is executed on a remote core processor. A global state of the parallel code segment is saved upon entry into the parallel file. In step 260, the timing of the commercial transaction is controlled by executing the parallel files simultaneously with the serial code segments. The timing of the commercial transaction is controlled by executing a portion of the parallel code segments as serial code segments.

The process described herein speeds up a single work task. When performing a batch of similar tasks, it is simpler and more efficient to use a parallel strategy of running tasks across an array of computers using the same unmodified program. If the user's response time to a hit is 10 seconds, then a thousand hit times would be no less than 10 seconds. When many users hit a website running on a few core processors, the response time goes up because all these users must share the same fixed number of processors. Each must wait for the other to finish. By having many core processors for users to access, each on average waits less time for the others. Running many copies of the website over a farm of computers causes the average response time of a high demand period to drop back down to that of a low demand period. The process never drops the average response time of a low demand period.

The process can also be used to convert documents into PDF files. The bytes of the document come in; get sliced into manageable chunks where each chunk is converted into its section of the PDF document, and the entire collection of chunks is streamed out to create the PDF file.

While one or more embodiments of the present invention have been illustrated in detail, the skilled artisan will appreciate that modifications and adaptations to those embodiments may be made without departing from the scope of the present invention as set forth in the following claims.

What is claimed is:

1. A method of controlling timing of a commerce transaction by transforming serial code segments into parallel code segments, comprising:
providing a plurality of code segments in an application which controls timing of a commercial transaction between first and second parties;
parsing the application by determining first ones of the code segments that must be executed as serial code segments and second ones of the code segments that can be executed as parallel code segments;
generating a parallel file for each of the parallel code segments, the parallel file containing the parallel code segment and the code segments of the application called by the parallel code segment;
transforming the application to associate each parallel file with the parallel code segment;
executing the application through the serial code segments and parallel code segments such that when encountering the serial code segment writing an output value of the serial code segment to an output stream and when encountering the location associated with the parallel file,
(a) writing a tag to the output stream to reserve a position in the output stream to write an output value of the parallel file when complete,
(b) executing the parallel file simultaneously with the serial code segment, and
(c) writing the output value of the parallel file in the reserved position of the output stream when the parallel file execution completes; and
controlling the timing of the commercial transaction by executing the parallel files simultaneously with the serial code segments.

2. The method of claim 1, wherein parsing the application further includes determining a first code segment that must be executed as a first serial code segment because the first code segment writes to a variable and a second code segment reads from the variable.

3. The method of claim 1, wherein the parallel code segments include the code segments of the application less the code segments that must be executed as serial code segments.

4. The method of claim 1, further including saving a global state of the parallel code segment upon entry into the parallel file.

5. The method of claim 1, further including controlling the timing of the commercial transaction by executing a portion of the parallel code segments as serial code segments.

6. The method of claim 1, further including:
executing the serial code segments on a local core processor; and
executing the parallel file on a remote core processor.

7. A method of controlling timing of a commerce transaction by transforming serial code segments into parallel code segments, comprising:
providing a plurality of code segments in an application which controls timing of a commercial transaction;
parsing the application by determining first ones of the code segments that must be executed as serial code segments and second ones of the code segments that can be executed as parallel code segments;
generating a parallel file for each of the parallel code segments, the parallel file containing the parallel code segment and the code segments of the application called by the parallel code segment;
transforming the application to associate each parallel file with the parallel code segment;
executing the application through the serial code segments and parallel code segments such that when encountering the serial code segment writing an output value of the serial code segment to an output stream and when encountering the location associated with the parallel file reserving a position in the output stream to write an output value of the parallel file when complete; and
controlling the timing of the commercial transaction by executing the parallel files simultaneously with the serial code segments.

8. The method of claim 7, wherein executing the application further includes:
executing the parallel file simultaneously with the serial code segment; and
writing the output value of the parallel file over the corresponding tag of the output stream when the parallel file execution completes.

9. The method of claim 7, further including displaying an advertisement during execution of the parallel code segment.

10. The method of claim 7, further including controlling the timing of the commercial transaction by executing a portion of the parallel code segments as serial code segments.

11. The method of claim 7, further including:
executing the serial code segments on a local core processor; and
executing the parallel file on a remote core processor.

12. A method of controlling timing of a commerce transaction by transforming serial code segments into parallel code segments, comprising:
providing a plurality of code segments in an application which controls timing of a commercial transaction;
parsing the application into serial code segments and parallel code segments;
executing the application through the serial code segments and parallel code segments such that when encountering the parallel code segment reserving a position in an output stream to write an output value of the parallel code segment when complete; and
controlling the timing of the commercial transaction by executing the parallel code segments simultaneously with the serial code segments.

13. The method of claim 12, wherein parsing the application further includes determining first ones of the code segments that must be executed as serial code segments and second ones of the code segments that can be executed as parallel code segments.

14. The method of claim 13, wherein parsing the application further includes determining a first code segment that must be executed as a first serial code segment because the first code segment writes to a variable and a second code segment reads from the variable.

15. The method of claim 12, further including displaying an advertisement during execution of the parallel code segment.

16. The method of claim 12, further including:
generating a parallel file for each of the parallel code segments, the parallel file containing the parallel code segment and the code segments of the application called by the parallel code segment; and
transforming the application to associate each parallel file with the parallel code segment.

17. The method of claim 16, wherein executing the application further includes:
executing the parallel file simultaneously with the serial code segment; and
writing the output value of the parallel file over the corresponding tag of the output stream when the parallel file execution completes.

18. The method of claim 12, further including:
executing the serial code segments on a local core processor; and
executing the parallel code segment on a remote core processor.

19. The method of claim 12, further including controlling the timing of the commercial transaction by executing a portion of the parallel code segments as serial code segments.

20. A computer program product, comprising computer readable program code embodied in a computer readable medium, the computer readable program code controlling timing of a commerce transaction by transforming serial code segments into parallel code segments, comprising:
providing a plurality of code segments in an application controlling timing of a commercial transaction;
parsing the application into serial code segments and parallel code segments;
generating a parallel file for each of the parallel code segment, the parallel file containing the parallel code segment and the code segments of the application called by the parallel code segment;
transforming the application to associate each parallel file with the parallel code segment;
executing the application through the serial code segments and parallel code segments such that when encountering the serial code segment writing an output value of the serial code segment to an output stream and when encountering the location associated with the parallel file reserving a position in the output stream to write an output value of the parallel file when complete; and
controlling the timing of the commercial transaction by executing the parallel files simultaneously with the serial code segments.

21. The computer program product of claim 20, wherein executing the application further includes:
executing the parallel file simultaneously with the serial code segment; and
writing the output value of the parallel file over the corresponding tag of the output stream when the parallel file execution completes.

22. The computer program product of claim 20, wherein parsing the application further includes determining first ones of the code segments that must be executed as serial code segments and second ones of the code segments that can be executed as parallel code segments.

23. The computer program product of claim 22, wherein parsing the application further includes determining a first code segment that must be executed as a first serial code segment because the first code segment writes to a variable and a second code segment reads from the variable.

24. The computer program product of claim 22, further including displaying an advertisement during execution of the parallel code segment.

25. The computer program product of claim 20, further including:
executing the serial code segments on a local core processor; and
executing the parallel file on a remote core processor.
